(19) United States
(12) Patent Application Publication
(10) Pub. No.: US 2016/0173186 A1
(43) Pub. Date: Jun. 16, 2016

(54) TELECOMMUNICATIONS RELAY FUNCTION AND DATA AGGREGATOR

(71) Applicant: VODAFONE IP LICENSING LIMITED, Newbury Berkshire (GB)

(72) Inventors: Lin LI, London (GB); Hamid FALAKI, London (GB)

(21) Appl. No.: 14/909,437

(22) PCT Filed: Aug. 4, 2014
(86) PCT No.: PCT/GB2014/052385

§ 371 Date: Feb. 1, 2016

(30) Foreign Application Priority Data
Aug. 2, 2013 (GB) 1313837.5

(51) Int. Cl. H04B 7/155; H04W 12/06; H04W 72/04

(52) U.S. Cl. CPC H04B 7/15535; H04W 72/0453; H04W 12/06

(57) ABSTRACT

The invention provides for an electronic apparatus for amplifying a plurality of different frequency bands of a wireless telecommunication signal. The apparatus comprises: a first antenna configured to receive a wireless communication signal; a filtering module configured to: receive an indication of a plurality of different frequency bands to be filtered; and, selectively filter the wireless telecommunication signal according to the received indication to form a filtered wireless telecommunication signal; a filter controller configured to provide the indication to the filtering module; and, an amplifier configured to amplify the filtered wireless communication signal.

### BACKGROUND

Wireless indoor coverage is becoming increasingly important to mobile network operators. It has been estimated that by 2016 over 80% of global wireless data traffic will be generated indoors. One of the major challenges for mobile operators has been to overcome indoor penetration loss particularly in underserved areas of radio access. The situation is exacerbated by the deployment of 3G & 4G technology where high frequencies have been adopted which suffer more from indoor penetration loss than low frequencies. Indoor penetration loss results in poor data quality, poor data transmission rates and high power requirements for transmission.

Typically there are two types of data services available to indoor users: the conventional digital subscriber line (DSL) and Wi-Fi router solution provided mainly by fixed line operators; and the Mobile Broadband (MBB) solution provided by mobile operators over 3G or 4G. MBB often suffers from inferior data throughput and stability which makes it very challenging for mobile operators to provide effective MBB service to customers, especially to families and Small and Medium Enterprises (SMEs).

One available method of enhancing indoor MBB signal is to deploy an indoor pico repeater. An indoor pico repeater enhances service in areas of weak signal where it is impractical to install a base station. Indoor pico repeaters typically include a donor antenna and a service antenna, each coupled to an amplifier. The signal is received by the donor antenna and amplified by the amplifier for transmission by the service antenna. The repeater is tuned to a particular narrow frequency band so that only that band, i.e. that carrier frequency, is amplified in order to reduce interference. There are several limitations to this solution.

One limitation of indoor pico repeaters is that they can only amplify the radio signal of one operator because the repeater is set to a particular frequency band. This may not be a problem in some scenarios; however it is particularly problematic in others. For example, the repeater cannot be used to provide services to families where different family members subscribe to different operators and may all need stable signal. Further, indoor pico repeaters are not appropriate for moving objects, such as ships or caravans, as amplification while roaming is not possible.

In another market segment there exist devices which can provide Wi-Fi signal using 3G or 4G to consumers if they live in areas without a good quality digital subscriber line (DSL). Unfortunately it is often the case that those areas having poor DSL quality are underserved areas of radio access, such as suburban and rural areas. In these scenarios the indoor signals are weak and unstable and so the 3G or 4G cannot be used. The degraded input signal will thus severely impact the Wi-Fi services. This situation may also occur in good outdoor coverage areas where there is high penetration loss and interference, for example in high density, large buildings.

There is therefore a need to improve MBB reach and capacity to cover areas and scenarios that are not easily served by either mobile or fixed network operators.

Additionally, consumer electronics with embedded Wi-Fi chipsets are far more predominant than those with 3G or 4G chipsets, for example tablet computers and laptops. As well as providing MBB services through a radio access network, it would be desirable to provide competitive Wi-Fi services to the consumer.

### SUMMARY OF THE INVENTION

According to a first aspect of the invention there is provided an electronic apparatus for amplifying a plurality of different frequency bands of a wireless telecommunication signal. The apparatus comprises: a first antenna configured to receive a wireless communication signal; a filtering module configured to: receive an indication of a plurality of different frequency bands to be filtered; and, selectively filter the wireless telecommunication signal according to the received indication to form a filtered wireless telecommunication signal; a filter controller configured to provide the indication to the filtering module; and, an amplifier configured to amplify the filtered wireless communication signal. The electronic apparatus may comprise a second antenna configured to transmit the amplified, filtered wireless communication signal.

By selectively filtering and amplifying different frequency bands in this way, the apparatus is able to amplify signals between devices and networks utilising different carrier frequencies. Thus data throughput can be increased for multiple users subscribed to different operators where there is high penetration loss such as office buildings. Further, the apparatus is able to increase data throughput for a single device that may utilise different operators over time without requiring multiple relays for each frequency. This may occur for example while roaming.

The electronic apparatus provides a means to efficiently and effectively relay transmissions on multiple different frequency bands. Not only does the apparatus provide increased data throughput, but additionally, provides significant power savings for telecommunications devices utilising the apparatus since transmissions will be amplified by the apparatus and are not required to reach the base station based solely on power provided by the device. This is particularly advantageous in mobile telecommunications and while travelling where power sources may not be readily available.

The electronic apparatus may further comprise: a modem module configured to demodulate the filtered wireless communication signal to provide one or more data streams; an aggregation processor configured to aggregate the data streams to provide an aggregated data stream; and, an interface module configured to transmit the aggregated data stream over a non-3GPP interface. In this way, data service may be provided to devices using a non-3GPP interface where only 3GPP services are available. Moreover, enhanced data throughput may be provided to a non-3GPP device by aggregating two data streams. This is particularly beneficial in areas of weak data coverage.

The interface module may be configured to receive data over the non-3GPP interface. The aggregation processor may be configured to assign the received data to a plurality of data streams associated with respective frequency bands.

The modem module may be configured to modulate the data streams for transmission using the respective frequency bands. The filtering module may be configured to combine the modulated data streams into an amalgamated wireless communication signal for transmission by the service antenna. The first antenna may be configured to forward the amalgamated wireless communication signal to public land mobile networks associated with the respective frequency bands.

In this way, improved data throughput may be provided to devices communicating using a non-3GPP interface when compared to the conventional method of using 3G or 4G to provide data services for non-3GPP interfaces. Weak radio coverage of multiple cells of different frequencies may be combined to provide improved data throughput. By using the filtering module of the relay function to provide the mixing, the significant efficiency savings are gained through the use of pooled radio frequency hardware.

The electronic apparatus may comprise a plurality of network authentication modules, each associated with a respective one of the public land mobile networks, the plurality of authentication modules being configured to authenticate the apparatus with associated public land mobile network. Thus the apparatus may be authenticated to transmit the data received from the non-3GPP interface to the public land mobile networks.

Additionally, the electronic apparatus may comprise a relay authentication module configured to authenticate the apparatus with an operations and management system. This provides for control and authorisation of relay function use.

The filter controller may retrieve the frequency bands to be filtered from one or more of the authentication modules. In this way the relay authentication module may store the appropriate filters or alternatively the filters may be paired to the network authentication modules and by extension the public land mobile networks with which the apparatus will be authenticated.

The filter controller may be configured to communicate with an operations and management system using one of the plurality of different frequency bands to retrieve the other frequency bands to be filtered. Optionally, the filter controller may be pre-programmed with the frequency bands to be filtered.

There may also be provided a method of amplifying a wireless telecommunication signal comprising a plurality of different frequency bands, each band being associated with a service provided by a wireless network operator. The method comprising: receiving an indication of a set of the plurality of different frequency bands to be filtered; selectively filtering the wireless telecommunication signal according to the received indication to form a filtered wireless telecommunication signal, and, amplifying the filtered wireless communication signal.

According to a further aspect of the invention, there may be provided an electronic apparatus configured to aggregate a plurality of signals, each signal derived from a first wireless communication signal and contained in a respective, distinct frequency band of the first wireless communication signal. Each frequency band may be associated with a respective authentication means and each authentication means may be associated with a respective mobile service operator. The first wireless communication signal may be received over one or more 3GPP air interfaces and the electronic apparatus may be configured to transmit the aggregated signal as a second wireless communication signal over one or more non-3GPP air interfaces.

A telecommunications system may also be provided which is adapted to carry out the above methods or incorporate the apparatus to utilise the principles of the present invention.

### BRIEF DESCRIPTION OF THE DRAWINGS

An example of the present invention will now be described in detail with reference to the accompanying drawings, in which:

FIG. 1 shows an exemplary scenario which is used to illustrate some of the benefits of the present invention;

FIG. 2 shows, schematically, a first example of the present invention;

FIG. 3 shows, schematically, a second example of the present invention;

FIG. 4 shows, schematically, a third example of the present invention in the context of the exemplary scenario of FIG. 1;

FIG. 5 shows a block diagram of an electronic apparatus according to an example of the present invention;

FIG. 6 shows a block diagram of a relay function and modem function of an electronic apparatus according to an example of the present invention;

FIG. 7 shows a process flow diagram of the operation of an example of the present invention; and,

FIG. 8 shows an example of aggregation of data at the IP level.

### DETAILED DESCRIPTION

In the following description, reference may be made to 3G and 4G and to particular standards. However, it should be understood that the present disclosure is not intended to be limited to any of these technologies. The present invention may also be applicable to a number of modes such as Time Division Duplex (TDD), Frequency Division Duplex (FDD), Time Division-Synchronous Code Division Multiple Access (TD-SCDMA), and High Speed Downlink Packet Access (HSDPA), among others.

While devices and apparatus are often referred to as “mobile” in the description, the term “mobile” should not be construed to require that a device will always be mobile merely that it has the capability of being in communication with a wireless telecommunications network which allows mobility. For instance, a PC terminal or a machine client that is never moved from a particular geographic location may in a sense still be considered mobile as it could be moved to a different location yet still access the same network. Where the term “mobile device” is used in the present discussion this is to be read as including the possibility of a device that is “semi-permanent” or even “fixed” where the context does not contradict such an interpretation.

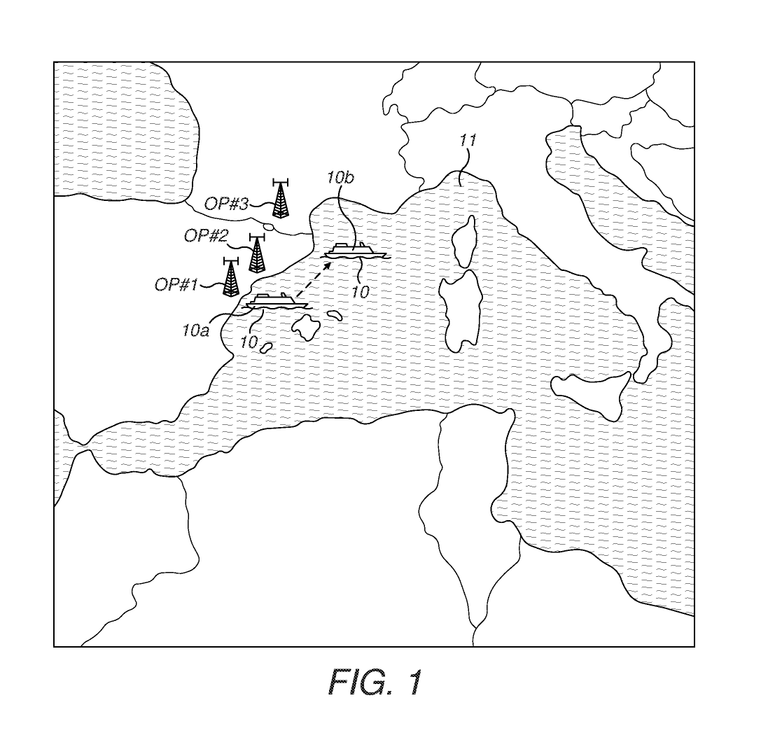

To demonstrate the benefits of the present invention and a potential use of the invention, an exemplary scenario of a ship travelling around the Mediterranean Sea will be used throughout the present description. Ships are not easily served by either mobile or fixed operators. Reference is made to this scenario in order to demonstrate certain principles and advantages. The exemplary scenario is depicted in FIG. 1. It is not intended for this example to impart any particular meaning to the invention and there may of course be myriad other potential uses and benefits of the invention. The scenario is merely exemplary.

One of the problems with using telecommunication devices on ships is that the ship itself is effectively a ‘big metal box’ and therefore devices inside the ship will suffer from significant penetration losses. Moreover, since base stations are typically located on land, the ship is likely to be at the extremities of cell coverage area. As such, telecommunication devices used on ships will most likely suffer from poor data quality and data throughput.

As illustrated in FIG. 1, an exemplary ship 10 may travel from location 10a to location 10b in the Mediterranean Sea 11. At a first location 10a, the ship is within range of two telecommunication cells operated by respective operators OP#1 and OP#2 each based in Spain. As the ship 10a travels to location 10b, the ship moves out of range of OP#1 and OP#2 and into range of a cell of OP#3 located in a different country, in this case France.

Conventional pico repeaters must be tuned to a narrow frequency band, effectively a single carrier frequency, in order to relay transmissions. It is therefore impractical for the ship 10 to install repeaters for each of the frequencies it will encounter. In the illustrated example, three repeaters would be required, one for each of OP#1, OP#2 and OP#3 respectively.

The present invention provides a means to efficiently and effectively relay transmissions on multiple narrow frequency bands. Not only does this provide increased data throughput, but perhaps more importantly, provides significant power savings for the telecommunications devices since transmissions will be amplified by the relay function of the present invention and are not required to reach the base station based solely on power provided by the device. This is particularly advantageous in mobile telecommunications and while travelling where power sources may not be readily available.

Each ship is also likely to have users subscribed to multiple operators and users operating multiple devices. When the ship is at location 10a, it may be in range of cells of both OP#1 and OP#2. Users may be subscribed to both OP#1 and OP#2 and each may require data service for their mobile device. The presently claimed invention allows for services to and from both OP#1 and OP#2 to be relayed within the same electronic apparatus. This is not conventionally possible. This is in part due to interference caused by amplifying a wide frequency range but also due to regulatory reasons. Amplifying a wide range of spectrum aimlessly may have a negative impact to networks. In regions where licensed spectrum is policed by regulator, it is mandatory to avoid aimless amplification of the wideband and thus relays must be tuned to a specific narrow frequency range.

An additional advantage of the present invention arises because devices on the ship may utilise multiple technologies for example 3GPP technologies such as 3G or 4G, as well as non-3GPP technologies, such as Wi-Fi or WiMAX. In order to provide service to the non-3GPP technologies, the present invention allows for data aggregation of multiple 3GPP data streams to provide enhanced data throughput to a non-3GPP interface. Thus, as the ship travels from location 10a to location 10b, high data throughput is maintained even though cell coverage may be poor.

Moreover, the invention may provide Mobile Broadband services to customers utilising a Wi-Fi terminal, even though their mobile operator does not provide coverage (or roaming) to those areas. It has become increasingly important to provide data services as access to Mobile Broadband has developed into a universal right in modern society.

Examples of the present invention will now be described in detail. An electronic apparatus is provided which performs a relay function suitable for amplifying and forwarding services signals transmitted in multiple disparate and separate narrow frequency bands such as data transmissions from multiple operators.

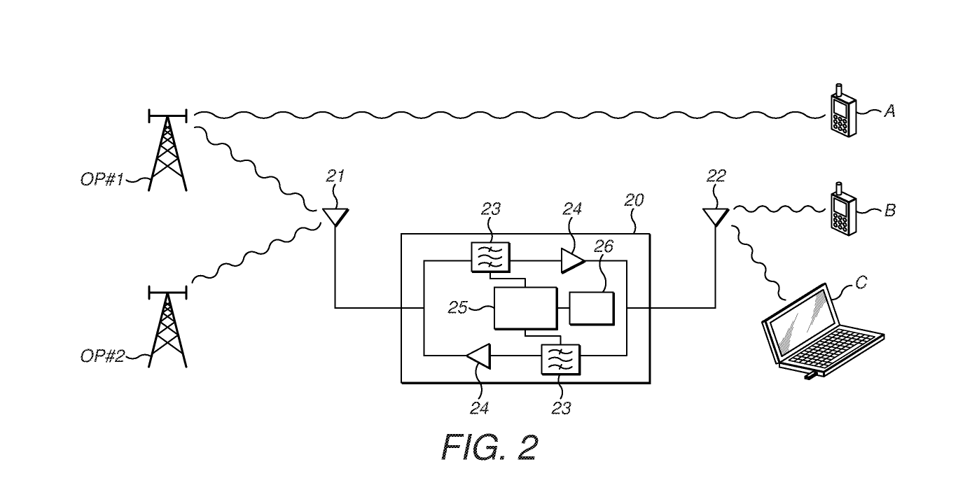

FIG. 2 illustrates, schematically, a relay 20 of the electronic apparatus. Three telecommunications devices are depicted A, B and C, each capable of communicating using a packet-switched telecommunications service. Devices A and B are subscribed to OP#1 and device C is subscribed to OP#2. For the purposes of this scenario, devices A, B and C are each located in the same vicinity. Device A communicates directly with a cell of OP#1 and is at the extremity of the cell coverage area. Device A uses significant power in transmitting to the cell and suffers from poor data throughput. Device B, also subscribed to OP#1, transmits and receives its data via relay 20.

Relay 20 includes a service antenna 21 and a donor antenna 22. The relay 20 functions to filter the wireless signal received by service antenna 21. The filtered signal is then amplified and forwarded to devices B and C by donor antenna 22. The relay 20 operates in both downlink, as described, and uplink. In the uplink phase, the antenna 22 receives transmissions from devices B and C which are then filtered and amplified before being transmitted to the base stations by the service station 21.

Functional modules of the relay 20 are depicted in FIG. 2. The relay 20 includes uplink and downlink filter modules 23 which are designed to selectively filter the signals before amplification by uplink and downlink amplification modules 24. The filter modules 23 are configured by a controller 25 which instructs the filters as to which narrow frequency bands should be filtered at that time.

A number of different ways of retrieving the frequency bands to be filtered are envisaged. Preferably, the relay 20 includes authentication means 26 operatively in communication with filter controller 25. The authentication means 26 authenticates the relay 20 with an operations and management system (not shown) of the telecommunications network(s) and the filter parameters are either stored in the authentication means or are received from the operations and management system. In this example, only once the relay 20 has been authenticated, is the filter controller allowed to filter the service and the relay 20 allowed to function. This provides for authorised relay use and prevents unregulated amplification.

Alternatively, the filter controller may be pre-programmed with a number of set frequency bands, may be locally programmed by an operator of the apparatus or may remotely receive the frequencies to be filtered from another source.

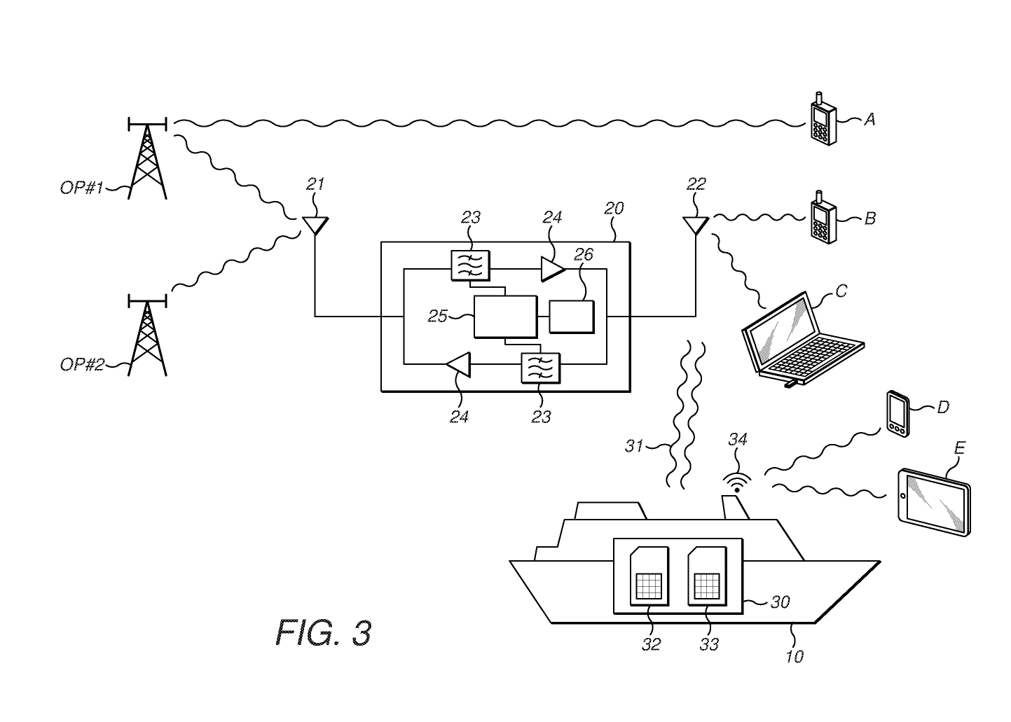

FIG. 3 schematically illustrates a further example of the present invention. In addition to the relay 20 and devices A, B and C, FIG. 3 depicts two further devices D and E. These devices may be capable of communicating via a non-3GPP interface such as Wi-Fi or WiMAX. Throughout the present description, the terms Wi-Fi, unlicensed band, and non-3GPP interface will be used interchangeably to mean the same communication interface. Similarly, this interface could be described as non-cellular.

For consistency, this example is depicted using the scenario described above with reference to FIG. 1 of the ship travelling around the Mediterranean Sea. In this example a data aggregation module 30 is shown which communicates with the relay 20, optionally with the service antenna 21 of the relay 20 using one or more 3GPP interfaces 31. Although depicted as separate entities, the relay 20 may be positioned on board the ship. The aggregation module includes authentication means 32 and 33 each paired with a respective operator OP#1 and OP#2. The data aggregation module 30 serves to aggregate data received and transmitted from OP#1 and OP#2 via the Wi-Fi interface 34. The aggregation module 30 uses the relay 20 to improve the data signal and reduce the power requirements. Devices D and E communicate using a Wi-Fi interface 34 and the data streams are selectively transmitted to OP#1 or OP#2.

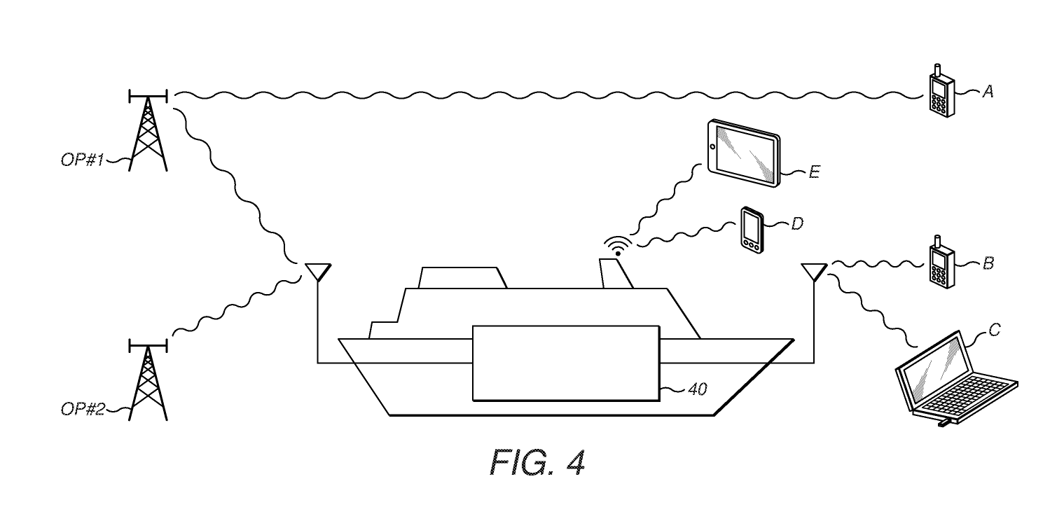

FIG. 4 schematically depicts a third example of the present invention in which the aggregation and relay functions pool hardware in order to provide efficiency savings. Preferably, the three described authentication means (the relay authentication means and the two network authentication means) may be provided within the same apparatus. The filter may be configured for frequency bands associated with any of the authentication means.

FIG. 4 depicts the pooled relay aggregation hardware as apparatus 40. The apparatus functions in the same way as the relay 20 and aggregation module 30 when provided independently. In addition to providing the filtering of the signals received from OP#1 and OP#2 before aggregation, the filters of the relay 20 provide the signal mixing or amalgamating using a duplexor towards the base stations of OP#1 and OP#2 to combine the signals from the data streams once split by the aggregation module 30 from the single data stream received over the wireless interface. Efficiency savings are therefore provided.

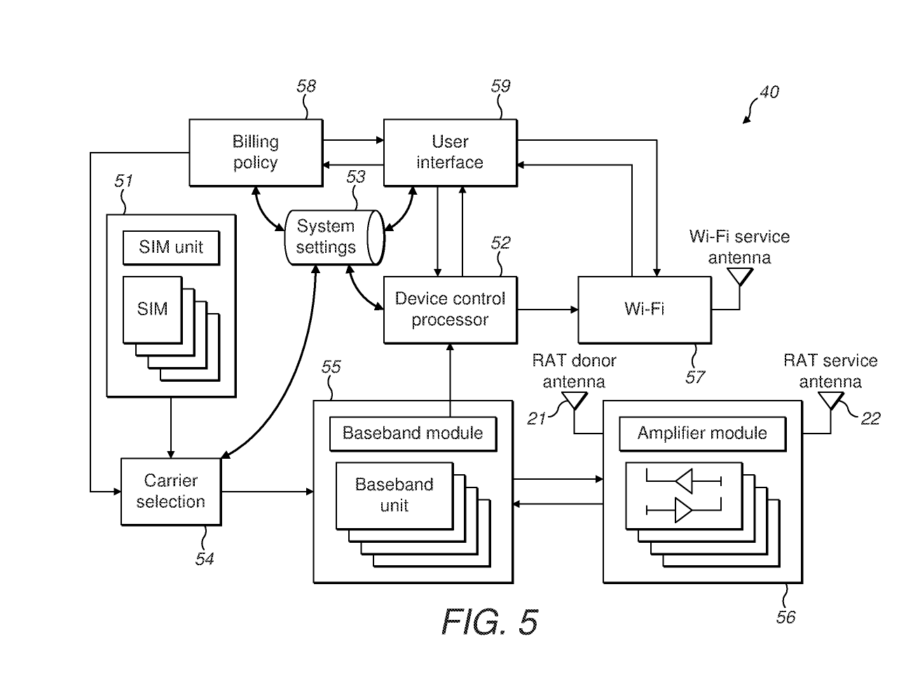

The combined apparatus will now be described in detail. FIG. 5 illustrates a schematic block diagram of the apparatus. Each module of the block diagram is configured to carry out certain tasks, however it will be understood that the tasks of each module may be combined or separated provided the functionality is equivalent. Each of the blocks of FIG. 5 will now be described individually along with the interactions between the blocks.

SIM unit 51 enables physical connectivity to multiple SIM cards. Two types of SIM profiles may be provided. The first type of SIM profile is for the activation and authentication of packet-switched services from a network. This profile acts in the same manner as a typical end user profile, in that the SIM profile provides connectivity to a 3G or 4G interface via a compliant 3GPP end user device. Each SIM profile is associated with a respective Public Land Mobile Network (PLMN). This type of SIM profile is utilised for the aggregation function. The signalling towards the network is defined by standardisation bodies. Each SIM effectively acts as an end user to a respective operator.

As described above, it may be preferable to authenticate the apparatus before activation, not least for regulatory reasons. A second type of SIM profile may be provided to activate the relay function of the apparatus and its operational parameters. This authentication may be between the apparatus and the network issuing the SIM. The apparatus may be authenticated with an operation and aintenance system (not shown) so that operation of the apparatus may be controlled.

The second type of profile may store information relating to the relay function of the apparatus and may provide relay operational data for relaying the telecommunications service specific to the operator issuing the SIM profile. The second type of profile may be designed so that it follows a set of secure protocols in conjunction with a network operation and maintenance system of a mobile operator. The apparatus may exchange its identity and capability by collecting the authorisation and operational frequency and power of the relay function for activation of the apparatus in the 3G or 4G frequency band of the operator issuing the SIM profile.

The SIM unit 51 may enable physical connectivity to multiple SIM cards however the SIM cards may also be embedded or virtual.

The control processor 52 is the main controller of the apparatus and determines the apparatus behaviour. Additionally, the processor 52 aggregates the traffic from one or more users on the non-3GPP frequency band towards one or more telecommunications networks serving the 3G or 4G frequency bands.

The systems settings block 53 is a database storing configuration parameters for exchanging information with the other modules of the apparatus.

The carrier selection block 54 acts based on the systems settings database 53 and enables the registration of the SIM profiles of the SIM unit 51 with a network based on the policy for traffic aggregation and management set by the system settings database 53.

The baseband module 55 provides modem functionality to provide a pool of baseband resources allocated to each registered SIM profile. This function enables radio and network access to the mobile broadband services of the operator issuing the SIM. This modem functionality is used for the Wi-Fi aggregation and also is used for the management of the relay unit by communicating the relay authentication procedure with network management system.

The amplifier module 56 serves to, in conjunction with the base band module 55, provide analogue modulation and demodulation of the signals toward the network(s) as well as the modem capability. The analogue module 56 additionally serves to enable a relay function based on the available SIM profiles in the SIM unit 51 and a policy of operations set by the control processor 52 and the system settings database 53. The amplifier module 56 pools the radio frequency resources, such as the filters, to efficiently provide both relay and modem functions.

The Wi-Fi module 57 serves as a Wi-Fi router using aggregated broadband capacity provided by the control processor 52 and the operation policy set in the system settings 53 to provide a Wi-Fi data service to electronic devices.

The billing policy block 58 works in cooperation with the control processor 52 to enable prioritisation of traffic flow and to enable billing for the services provided by the apparatus.

The user interface 59 provides access to the system settings database 53 for the desired operation of the control processor 52. Examples of the possible configurations include:
setting the end user's preferred policy in controlling the use of the data plans offered by each operator;
controlling access the services provided by 3GPP or non-3GPP interfaces;
limiting traffic aggregation from multiple 3G or 4G frequency bands to the Wi-Fi module;
controlling the relay function for traffic sharing between the 3G or 4G frequency band and the Wi-Fi users; and,
other known forms of standard file or router control.

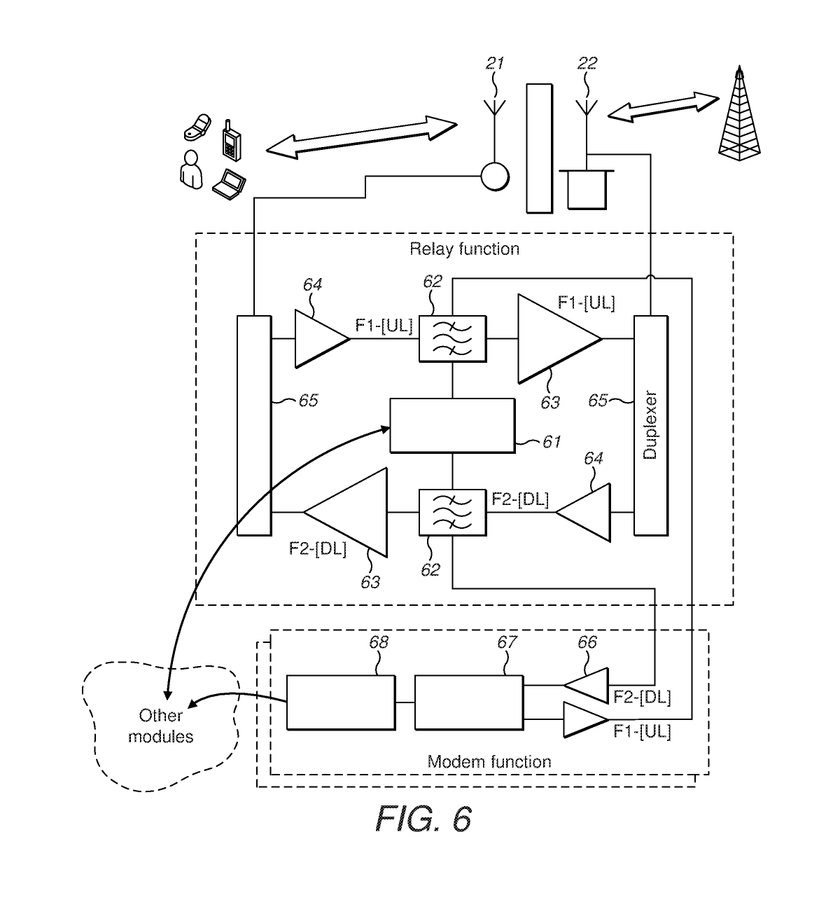

The function of the amplifier module 56 will now be described with reference to FIG. 6 which illustrates a schematic of the relay and modem functions. The amplifier module 56 may be considered to be a combination of a modem function and a relay function. Operatively, the analogue radio frequency (RF) circuits are shared to perform either relay operation or modem functionality. The filters and amplifiers operating in uplink and downlink were schematically illustrated in FIGS. 2 and 3 but are illustrated and described in more detail here using new reference numerals.

FIG. 6 illustrates a filter logic controller 61 which programs the filter 62 for the selected carrier frequency. The filter 62 serves two functions.

The first function of the filters 62 is to filter the selected carrier frequency before amplification by amplifiers 63. Again, the filters 62 and amplifiers 63 operate in either an uplink or downlink configuration. The apparatus thus contains an uplink filter as well as a downlink filter and an uplink amplifier as well as a downlink amplifier. For simplicity the filters 62 and amplifiers 63 may be referred to in combination throughout.

The RF signal is forwarded to either the device by donor antenna 21 or the base station via service antenna 22. The carrier frequencies to be filtered may be retrieved from the carrier selection module by the filter controller and may be retrieved via the authentication process or may be pre-programmed. Other filter parameters may be retrieved remotely from the operations and management system or may be locally programmed.

The second function of the filters 62 is to provide RF signal mixing towards the donor base station to combine the RF signals from the modem functionality of the base station towards the rest of the apparatus. As illustrated, the signal to and from the filters 62 goes to the modem function before the power amplifiers 63. The mixing function of the filters 62 is used to enable the communication of the apparatus with the operator base stations and also the communication to authenticate the SIM modules for their respective functions. The mixing function also enables the relay function and modem functions to optimise the use of RF circuitry in providing the mixed operation of relay function as well as the modem function for capacity aggregation.

A low noise amplifier 64 is positioned before the filters 62 to amplify possibly weak signals before filtering. Uplink and downlink duplexers 65 allow bi-directional communication over a single path.

By pooling the hardware in this way, efficient functionality is provided. A “single box solution” is provided that relays multiple operator frequency bands whilst protecting each operator's frequency band from interference associated with the benefit of using a relay. Power savings are provided due to the hardware pooling in relaying multiple operator frequency bands from one RF amplifier where the operator's frequency band is close enough for the relay to pool RF resources. Additionally, power savings are provided due to the pooling of baseband operation.

The modem function includes amplifier 66 which provides pre-amplification of the analogue signal making it ready for the mixing function provided by the filter 62 and duplexer 66. This means the design of the filter 66 and duplexer 62 will have multiple inputs for multiple instances of the modem function and circuits.

The modem function also includes a synthesiser 67 which performs signal conditioning. The synthesiser 67 generates a range of frequencies from a single fixed oscillator. The function of this module is well known in the art to produce the desired analogue or digital output signal based on required modulation method of the air interface as used for the communication. There are multiple instance of this circuit as a pool of synthesiser circuits. In this way the solution as a whole allows selection of any one of such circuit from the pool based on the required communication needs. This selected circuit then is maintained as a dedicated circuit to the needs of the relay function at the time of the demand for such communication. After the demand for modem resource is completed the circuit becomes part of the pool and power resources are further optimised to reflect reduced functionality until the demand for this modem operation comes again in real time of operating the relay or modem functionality.

A base band processor 68 provides digital modulation for the required air interface signal processing and control, as an input to the synthesiser. There are multiple instance of the circuits processing real time radio reception and transmission operations as required for the operational need of the relay solution. In a similar way as described for the synthesiser this circuit is also operated as pool of resources on communication demand from the relay or modem function of the overall solution.

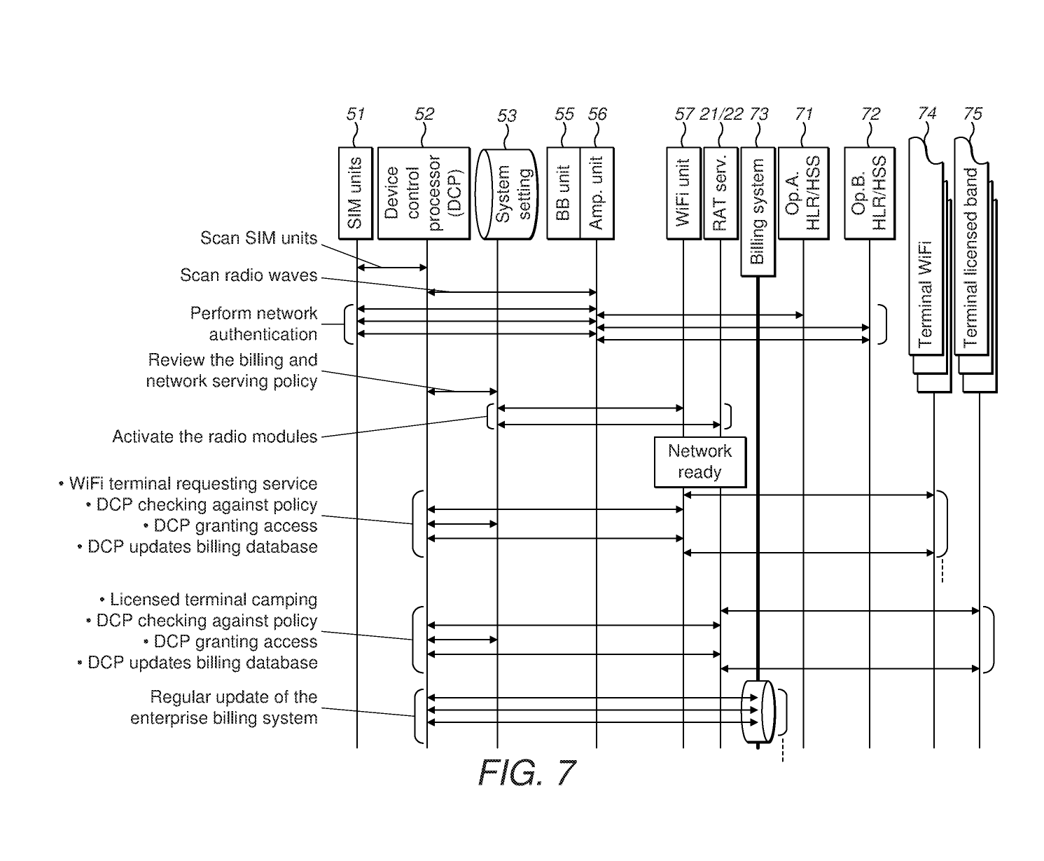

The operation of the electronic apparatus is illustrated in FIG. 7 as an example of the signalling used in delivering service. Each step in the process is typically controlled by the control processor 52. FIG. 7 illustrates the communication and operation of the SIM units 51, the control processor 52, the system settings database 53, the baseband units 55, the amplifier unit 56, the Wi-Fi unit 57 and radio access technology (RAT) antennas 21 and 22.

Upon system power up, the control processor 52 scans the SIM unit 51. The control processor 52 then configures the relay and modem functions of the baseband module 55 and amplifier module 56 with the frequencies to be filtered based on the list of network IDs for the serving public land mobile network (PLMN) operators stored in the SIM profiles of the SIM unit 51. The control processor 52 then scans the radio waves and available radio access technologies of operators in the list for service provisioning. The control processor 52 then camps on available PLMN networks based on subscription availability (from SIM unit 51). The apparatus is then authenticated by each PLMN on which the apparatus is camped via the security settings in each of the SIM profiles associated with each respective PLMN.

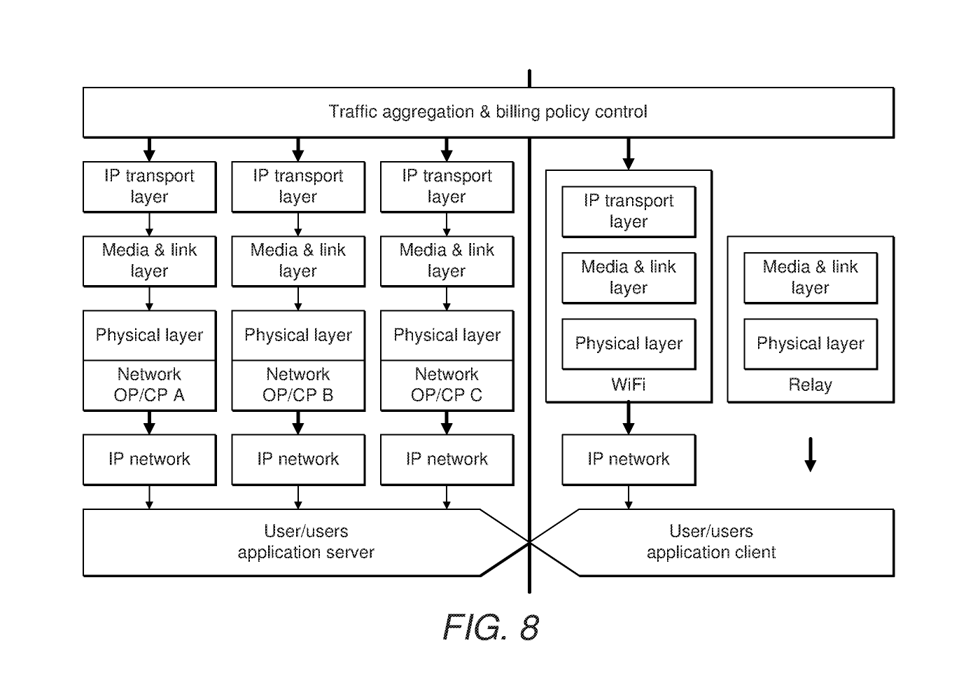

The control processor 52 then authenticates the relay function of the apparatus with a remote operations and management server. FIG. 8 illustrates the operations and management server as forming part of the network of operator B however it would be understood that this operations and management server may be separate to the network or integral with it. In response to authentication, the server may reply with operational parameters for the relay function.

The control processor will next review the billing policy to activate radio communication, i.e. the aggregation and relay functions.

Based on the system settings database 53, the control processor 52 may then activate the radio access technology antennas to offer mobile broadband services, i.e. the relay function, in either open, closed or hybrid user access control. Open mode means all users of the selected operators are allowed to use the amplified signal. Closed mode means only selected users, for example those willing to pay or belong to a certain user club, are allowed to use the amplified signal. Hybrid mode is the combination, which means some users get higher priority over the others to access the network and some advance service like secured connection.

Based on the system settings database 53 and the specific requirements, the control processor 52 may then activate the Wi-Fi module 57 to offer aggregated data throughput capability and service to users connected via the Wi-Fi interface.

The electronic apparatus is now ready for to perform both aggregation and relay functions.

It has been described above that the control processor 52 aggregates data received in the 3G or 4G frequency band, i.e. from 3GPP operators, and transmits this data to an end user using an unlicensed band, i.e. a non-3GPP interface such as Wi-Fi. FIG. 8 illustrates the aggregation of traffic at the IP level based on known methods for multiple IP links used to serve one IP link towards an application in a server.

The baseband module 55, in conjunction with control processor 52, provides a data stream to the processor 52 for each demodulated signal received from each 3GPP network over a particular carrier frequency. At the control processor 52, these multiple data streams are aggregated and passed over the Wi-Fi interface to a single end user. The skilled person would recognise that any known methods of IP aggregation may be used such as flow aggregation.

The basic functionality of the electronic apparatus has been described above. The electronic apparatus pools radio frequency circuits and provides both amplification and forwarding of 3G or 4G transmissions over multiple narrow frequency bands and provides aggregation over a Wi-Fi interface of data sent to or from mobile networks using 3G or 4G.

Once operational, the apparatus may be further operable to allow users to configure the billing policy controller 58 via a user interface 59 to choose how the aggregation is to be performed. The coordination between the billing policy controller 58 and the control processor 52 enables aggregation of the traffic towards the users in many ways. For example, traffic offered in relay mode may take precedence to the traffic offered over Wi-Fi or vice versa. Further, traffic offered on a Wi-Fi network may be aggregated over the IP connections towards the network as a single IP connection to serve a single user or multiple users in a serving Wi-Fi area, that is one user in a Wi-Fi network through one or more applications may access all the traffic capacity by all the active networks in response to the running application on its device. This process may be executed by the aggregator logic in the control processor 52 and pass the length of the capability to another device in the queue for service.

Alternatively, the traffic aggregation may use traffic panning from one network operator with a lower tariff to ensure an overall lower cost in providing mobile broadband service to users in the Wi-Fi coverage area. Additionally, once the traffic plan from one operator is consumed, the billing policy and control processor 52 may consider the use of a traffic plan from the next network offering a lower tariff. Further, the example above may also be operated based on service quality as the means of selecting the network serving a pool of Wi-Fi users. In which case, the best serving network, i.e. with the best throughput or latency, will provide the required service or a higher proportion of the required service. Other examples of traffic aggregation or limitation are of course envisaged.

FIG. 7 further illustrates how billing for the service provided by the apparatus may be performed. First, as shown, a Wi-Fi device 74 requests service from the apparatus. The control processor 52 checks against the billing policy and grants access based on the system settings 53. The control processor 52 then updates a billing database. Within the system setting 53, this database stores the preferred operators of the relay as set by the owner.

If a device 75 operating over 3G or 4G camps on a network using the relay, the control processor 52 checks the billing policy controller 58 and grants access based on this and the system settings database 53. The control processor 52 then updates its billing database. The database is the subset of the information related to billing within the system setting 53 of FIG. 5.

As the Wi-Fi device and 3G or 4G device utilise the apparatus, regular update of the billing system is performed.

In the description above, a relay has been described which amplifies 3G or 4G service over multiple frequencies and further provides for aggregation of multiple 3G or 4G data services and transmittal of this aggregated data service over a non-3GPP interface. The use of such an apparatus in a ship which moves between cells of multiple operators utilising multiple frequencies was described, however there are other contemplated benefits to employing the described apparatus. The present invention offers service selection for the end user based on the traffic offered by each network. Moreover, the aggregation of data and transmission over Wi-Fi allows for high data throughput since weak coverage of two separate networks may be combined to provide acceptable data quality and alleviate indoor penetration loss.

It is important to note that the described examples of using such equipment on a ship are merely for illustrative purposes. The same apparatus could be used on other vectors and/or vehicles, such as trains, buses, etc. For example, a train moving along a track which could be served by one or more network operators (even within the same country) may significantly benefit from using the apparatus in similar ways as the ship does.

1. An electronic apparatus for amplifying a wireless telecommunication signal comprising a plurality of different frequency bands, each band being associated with a service provided by a wireless network operator, the apparatus comprising:
a filtering module configured to:
receive an indication of a set of the plurality of different frequency bands to be filtered; and,
selectively filter the wireless telecommunication signal according to the received indication to form a filtered wireless telecommunication signal, and
an amplifier configured to amplify the filtered wireless communication signal.

2. An electronic apparatus according to claim 1, further comprising:
a first antenna configured to receive a wireless communication signal; and
a second antenna configured to transmit the amplified, filtered wireless communication signal.

3. An electronic apparatus according to claim 1, further comprising:
a modem module configured to demodulate the filtered wireless communication signal to provide one or more data streams;
an aggregation processor configured to aggregate the data streams to provide an aggregated data stream; and
an interface module configured to transmit the aggregated data stream over a non-3GPP interface.

4. An electronic apparatus according to claim 3, wherein:
the interface module is configured to receive data over the non-3GPP interface;
the aggregation processor is configured to assign the received data to a plurality of data streams associated with respective frequency bands;
the modem module is configured to modulate the data streams for transmission using the respective frequency bands; and
the filtering module is configured to combine the modulated data streams into an amalgamated wireless communication signal for transmission.

5. An electronic apparatus according to claim 4, wherein the first antenna is configured to forward the amalgamated wireless communication signal to public land mobile networks associated with the respective frequency bands.

6. An electronic apparatus according to claim 4, further comprising:
a plurality of network authentication modules, each associated with a respective one of the public land mobile networks, the plurality of authentication modules configured to authenticate the apparatus with associated public land mobile networks.

7. An electronic apparatus according to claim 1, further comprising:
a relay authentication module configured to authenticate the apparatus with an operations and management system.

8. An electronic apparatus according to claim 7, further comprising a filter controller configured to provide the indication to the filtering module, wherein the filter controller retrieves the frequency bands to be filtered from the relay authentication module.

9. An electronic apparatus according to claim 1, further comprising a filter controller configured to provide the indication to the filtering module, wherein the filter controller is configured to communicate with an operations and management system using one of the plurality of different frequency bands to retrieve the other frequency bands to be filtered.

10. An electronic apparatus according to claim 1, further comprising a filter controller configured to provide the indication to the filtering module, wherein the filter controller is pre-programmed with the frequency bands to be filtered.

11. An electronic apparatus according to claim 1, further comprising a filter controller configured to provide the indication to the filtering module, wherein the indication is provided based on the service to be received from the wireless network operators.

12. A method of amplifying a wireless telecommunication signal comprising a plurality of different frequency bands, each band being associated with a service provided by a wireless network operator, the method comprising:
receiving an indication of a set of the plurality of different frequency bands to be filtered;
selectively filtering the wireless telecommunication signal according to the received indication to form a filtered wireless telecommunication signal amplifying the filtered wireless communication signal.

13. A method according to claim 12, further comprising:
receiving the wireless communication signal; and
transmitting the amplified, filtered wireless communication signal.

14. A method according to claim 12, further comprising:
demodulating the filtered wireless communication signal to provide one or more data streams;
aggregating the data streams to provide an aggregated data stream; and transmitting the aggregated data stream over a non-3GPP interface.

15. A method according to claim 14, further comprising:
receiving data over the non-3GPP interface;
assigning the received data to a plurality of data streams associated with respective frequency bands;
modulating the data streams for transmission using the respective frequency bands; and
combining the modulated data streams into an amalgamated wireless communication signal for transmission.

16. A method according to claim 15, further forwarding the amalgamated wireless communication signal to public land mobile networks associated with the respective frequency bands.

17. A method according to claim 15, further comprising:
authenticating the apparatus with a plurality of public land mobile networks, each public land mobile networks being associated with a respective network authentication module of the apparatus.

18. A method according to claim 12, further comprising:
authenticating the apparatus with an operations and management system.

19. A method according to claim 18, further comprising retrieving the frequency bands to be filtered from the an operations and management system.

20. A method according to claim 12, further comprising communicating with an operations and management system using one of the plurality of different frequency bands to retrieve the other frequency bands to be filtered.

21. A method according to claim 12, in which the apparatus is pre-programmed with the frequency bands to be filtered.

22. A method according to claim 12, further comprising in which the indication is provided based on the service to be received from the wireless network operators.

23-25. (canceled)
